(19) United States
(12) Patent Application Publication
(10) Pub. No.: US 2008/0016355 A1
(43) Pub. Date: Jan. 17, 2008

(54) Remote Control Method Enabling a User to Control the Operation of a Receiving Unit

(75) Inventors: Frederic Beun, Chatou (FR); Laurence Boudier, Chatou (FR)

Correspondence Address: PEARNE & GORDON LLP, 1801 EAST 9TH STREET, SUITE 1200, CLEVELAND, OH, 44114-3108, US

(73) Assignee: VIACCESS, Paris La Defense Cedex (FR)

(21) Appl. No.: 11/570,131

(22) PCT Filed: Jun. 27, 2005
(86) PCT No.: PCT/FR05/50500

§ 371 Date: Dec. 7, 2006

(30) Foreign Application Priority Data
Jun. 29, 2004 (FR) 0451355

(51) Int. Cl. H04L 9/32; G06F 11/00; G06F 12/14; H04L 9/00

(52) U.S. Cl. 713/172; 713/150; 713/170; 713/193; 714/712; 714/E11.017

(57) ABSTRACT

The invention relates to a method for an operator to have remote control over the use of reception equipment in a digital data broadcasting network. This method comprises the following steps: a—defining a set of tests that can be remotely activated in said reception equipment and the results of which can be used to identify at least one particular use of at least one part of the reception equipment, b—defining a set of actions that can be executed in said reception equipment designed to control operation of said equipment, c—associating at least one action defined in step b), with each test defined in step a), d—remotely activating by the operator at least one test among the tests defined in step a).

### TECHNICAL FIELD

The invention aims at preventing hacking digital data broadcast in scrambled form by an operator to users with access rights.

More specifically, the invention relates to a method for remote controlling by an operator of the use of reception equipment in a digital data broadcasting network.

In particular, the purpose of control is to detect any fraudulent manipulation for descrambling said data.

The invention also relates to reception equipment comprising a decoder and a security processor adapted to implement the method. For example, the security processor may be a smart card.

### STATE OF PRIOR ART

In a classical conditional access control system, the access right is checked by considering conditions to be satisfied by user reception equipment with regard to the access control technology used, the operator providing the data, or this operator's commercial strategy. This operator transmits an Entitlement Control Message (ECM) to reception equipment containing the conditions to be satisfied for accessing to the scrambled data, an encrypted Control Word (CW) to descramble these data, and an Entitlement Management Message (EMM) containing access rights of each user to be written in the smart card.

In addition to the information necessary for access control, mechanisms for detection of abnormal use of the decoder or the smart card are provided in the reception equipment. A disadvantage of these mechanisms is due to the fact that they are only capable of detecting fixed elementary situations for example such as syntax errors in messages or electrical or time based behaviors not corresponding to a predefined template. Consequently, it is easy for frauders to analyse these mechanisms and to correct detection messages or the electrical or time behavior of signals outside the predefined templates, to prevent the operator from detecting the fraud.

The purpose of the invention is to efficiently hide detection and sanction mechanisms used by the operator, so that they cannot be seen by pirates.

Another purpose of the invention is to enable the operator to dynamically control the detection method and to remotely apply an appropriate sanction to each detected fraud.

In the remainder of the description, the term detection defines processing done in the reception equipment, for example consisting of analysing the current usage context defined by functional and/or time criteria, so as to identify the occurrence of a situation predefined by the operator.

The term sanction defines predefined processing that can be executed by the reception equipment with the objective of causing particular operation of the reception equipment.

### PRESENTATION OF THE INVENTION

The invention recommends a method for an operator to have remote control over the use of reception equipment in a digital data broadcasting network applicable to any type of detection and any type of sanction.

This method comprises the following steps:

a—defining a set of tests that can be remotely activated in the reception equipment of a user and the results of which can be used to identify at least one particular use of at least one part of this reception equipment,

b—defining a set of actions that can be executed in said reception equipment designed to control operation,

c—dynamically and remotely associating at least one action defined in step b), with each test defined in step a),

d—remotely activating by the operator at least one test among the tests defined in step a).

This method also includes a step consisting of remotely triggering at least one action associated with a test activated as a function of the result of said test.

Thus, the operator can use the invention to remotely vary detection mechanisms, sanction mechanisms and relations between them, in the decoder and in its security processor.

Preferably, an action associated with a given test is triggered according to a time sequence programmed by the operator.

According to the invention, each defined test is either an elementary test or a combination of elementary tests pre-programmed in the reception equipment, and each defined action associated with said test is either an elementary action or a combination of elementary actions pre-programmed in the reception equipment.

The method according to the invention can be used in reception equipment comprising a decoder and a security processor.

This reception equipment also comprises means of executing a set of predefined tests to detect particular use of the decoder or the security processor, and means of executing at least one action previously associated with the executed test, using a time sequence predefined for each particular detected use.

Preferably, the reception equipment is connected through a backward channel to a central management site to transmit a record of the tests and actions executed, to this central site.

The invention also relates to a decoder designed to cooperate with a security processor to control access to scrambled digital data broadcast by an operator to a set of a reception equipment. This decoder comprises:
a non-volatile memory containing at least one predefined test to detect particular use of the decoder or the security processor, and at least one predefined action associated with said test that can be activated remotely by the operator,
a first module designed to execute at least one of the memorised tests,
a second module designed to execute at least one action associated with the executed test, according to a time sequence predefined for each particular detected use.

The invention also relates to a computer program that can be executed on a set of reception equipment that can receive digital data broadcast by an operator and each including a decoder and a security processor. This program includes instructions to execute a set of tests previously memorised in the decoder to detect a particular use of said decoder or said security processor and instructions to execute at least one action associated with the executed test, according to a time sequence predefined for each particular detected use.

### BRIEF DESCRIPTION OF THE DRAWINGS

Other characteristics and advantages of the invention will become clear after reading the description given below as a non-limitative example, with reference to the appended figures in which:

FIG. 1 diagrammatically shows the structure of a message carrying orders to activate a test and orders to trigger actions associated with the activated test,

FIG. 2 shows a flow chart diagrammatically illustrating essential steps in the method according to the invention.

### DETAILED PRESENTATION OF PARTICULAR EMBODIMENTS

The following description relates to a particular application of the method in a system for broadcasting audiovisual programs comprising a central management site located at an operator and a set of reception equipment, each equipment comprising a screen, a decoder and a security processor composed of a smart card.

The central management site comprises a programmable module that the operator uses to define a set of tests to detect abnormal or unauthorised use of the decoder or the smart card, a set of actions that the operator can trigger at any time depending on the result of the executed test(s), a list of test/action associations, and a time sequence related to each test/action association.

The central management site is also provided with means of transmitting a description of the defined tests, a description of the defined actions, a description of the test/action association list and description of the time sequence related to each test/action association, to each decoder.

The central management site also comprises a control module that the operator uses to remotely activate one or several tests in each decoder among the predefined tests, and remotely trigger at least one action associated with the activated test depending on the result of said test. An action may be triggered by the operator at any time or according to a predefined sequence depending on the nature of the broadcast programs. Detection of abnormal use and subsequent sanctions are decorrelated in time such that pirates will be unable to reconstitute the chronology of these two operations.

The method according to the invention can be applied in the case in which the operator would like to target a determined set of reception equipment. In this case, the test consists of:
checking the authenticity of the signal broadcast by the operator and received by the decoder, or
checking that the card used contains the operator's identifier.

The action may consist of:
displaying a warning message, or
refusing to descramble the broadcast programs, or
temporarily or permanently blocking the terminal and/or the smart card.

The tests and actions may be combined as a function of the usage context and the type of broadcast programs. The operator sends a description of the defined tests to each reception equipment together with a description of the defined actions, a description of the list of test/action associations and a description of the time sequence related to each test/action association. The operator may send these descriptions at any time. These descriptions are encrypted in advance and recorded in a non-volatile memory of the reception equipment.

Said descriptions are transmitted to the reception equipment in a secure EMM message or in a private data flow. Similarly, the order to activate a test and the order to start execution of an action associated with an activated test are also transmitted to the reception equipment in secure EMM messages.

In another variant embodiment of the invention, these orders are transmitted to the reception equipment in a private data flow.

After application of the method in reception equipment, the reception equipment may transmit a record of executed tests and actions to the operator.

Addressing of EMM Messages

EMM messages used for configuration and use of the test/action feature according to the method according to the invention are emitted in an EMM channel of a digital multiplex as defined by the MPEG2/System standard and DVB/ETSI standards.

This channel may distribute EMMs transporting addressing data used to transmit these EMMs:
to a particular decoder,
to a particular group of decoders,
to all decoders.

Messages intended to a particular decoder are EMM-U messages with the following structure:

| | |
|---|---|
| EMM-U_section( ) { | |
| table_id = 0x88 | 8 bits |
| section_syntax_indicator = 0 | 1 bit |
| DVB_reserved | 1 bit |
| ISO_reserved | 2 bits |
| EMM-U_section_length | 12 bits |
| unique_address_field | 40 bits |
| for (i=0; i<N; i++) { | |
| EMM_data_byte | 8 bits |
| } | |
| } | |

The unique_address_field parameter is the unique address of a decoder.

Messages intended to a particular group of decoders are EMM-S messages with the following structure:

| | |
|---|---|
| EMM-S_section( ) { | |
| table_id = 0x8E | 8 bits |
| section_syntax_indicator = 0 | 1 bit |
| DVB_reserved | 1 bit |
| ISO_reserved | 2 bits |
| EMM-S_section_length | 12 bits |
| shared_address_field | 24 bits |
| reserved | 6 bits |
| data_format | 1 bit |
| ADF_scrambling_flag | 1 bit |
| for (i=0; i<N; i++) { | |
| EMM_data_byte | 8 bits |
| } | |
| } | |

The shared_address_field parameter is the address of the group of decoders. A decoder in a group is concerned by the message if it is also explicitly denoted in an ADF field contained in EMM_data_byte and that can be encrypted using ADF_scrambling_flag information.

Messages intended to all decoders are EMM-G messages with the following structure:

| | |
|---|---|
| EMM-G_section( ) { | |
| table_id = 0x8A or 0x8B | 8 bits |
| section_syntax_indicator = 0 | 1 bit |
| DVB_reserved | 1 bit |
| ISO_reserved | 2 bits |
| EMM-G_section_length | 12 bits |
| for (i=0; i<N; i++) { | |
| EMM_data_byte | 8 bits |
| } | |
| } | |

Content of EMM Messages

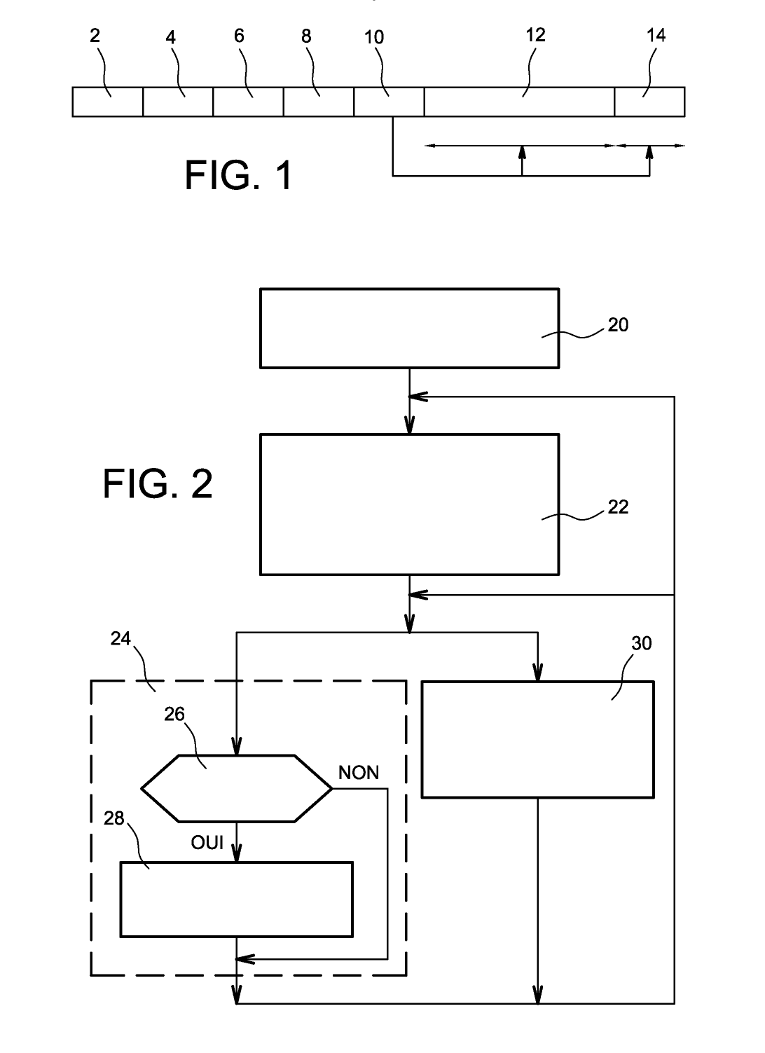

FIG. 1 diagrammatically shows the content of EMM_data_byte data in an EMM message controlling the test/action feature. This content depends on the function to be executed by the decoder for configuration or use of the test/action feature.

EMM_data_byte data include the following functional parameters:
ADF 2: addressing complement of a decoder in a group of decoders; this parameter is useful in the case of addressing by group, otherwise it can be omitted; it may be encrypted,
SOID 4: identification of test/action feature control messages according to the invention, among other types of messages,
OPID/NID 6: identification of the set of decoders and the operator's signal,
TIME 8: time stamping data when the message is sent; this parameter is used to prevent the message from being replayed by the same decoder,
CRYPTO 10: identification of cryptographic protection functions applied to FUNCTIONS 12 parameters.

FUNCTIONS parameters may be encrypted and protected by cryptographic redundancy 14.
FUNCTIONS 12: set of parameters describing the configuration and use of the configuration and use of the tests/action feature”.

The functional parameters mentioned above are freely organised in EMM_data_byte data of an EMM message. One preferred implementation is the combination of these parameters using the T L V (Type Length Value) structure.

Configuration and Use of the Test/Action Feature

All FUNCTION 12 parameters describe the configuration and use of the test/action feature according to the invention. This set of parameters is an arbitrary combination of the following functional parameters:
DESCR_TEST: this parameter describes a test; it comprises the test identifier, optionally the description of each elementary test that makes up the test, and optionally test configuration parameters:
   each elementary test is described by an identifier of the elementary test and optionally by configuration parameters of the elementary test,
   test or elementary test configuration parameters comprise an optional generic mask applicable to test or elementary test input data and optional test or elementary test comparison data.
DESCR_ACTION: this parameter describes an action; it comprises the action identifier, optionally the description of each elementary action that makes up the action, and optionally configuration parameters of the action:
   each elementary action is described by an identifier of the elementary action and optionally by configuration parameters of the elementary action,
   configuration parameters of the action or an elementary action comprise an optional generic mask applicable to action or elementary action input data and optional action or elementary action input data.
ASSOC_TEST_ACTION: this parameter describes the association between a test and actions: it comprises the test identifier and a list of action identifiers associated with this test,
CDE_TEST: this parameter is used to order a test; it comprises the identifier of the test to be ordered, the nature of the order (activate, deactivate, cancel the result) and time conditions for activation of the test (on date, at intervals, immediately, at random),
CDE_ACTION: this parameter is used to order an action: it comprises the identifier of the action to be ordered, the nature of the order (start, cancel a started action) and time conditions for starting the action (on date, immediately, at random),

The functional parameters given above are freely organised in the set of FUNCTIONS 12 parameters. One preferred implementation is the combination of these parameters by T L V (Type Length Value) structure.

The essential steps in the method according to the invention will now be described with reference to FIG. 2.

Step 20 consists of functionally defining elementary tests and elementary actions in the central management site and in the receiver.

The step 22 consists of sending a description of tests composed of elementary tests, a description of actions composed of elementary actions, a description of the list of test/action associations and/or a description of the time sequence related to each test/action association, to reception equipment. This step is done at the operator by the central management site.

Step 24 consists of applying the method dynamically in reception equipment.

Note that detection can be conditional, in other words related to the occurrence of a predefined situation for example such as introduction of an unauthorised card into the decoder. In this case, the terminal equipment only executes the predefined test corresponding to this situation if the operator activates the test and if the predefined situation is detected.

A detection may be unconditional, in other words independently of the use context of the terminal equipment. In this case, the terminal equipment automatically executes the test corresponding to a predefined situation as soon as the operator has activated the test.

The preferred method of performing the invention consists of executing a detection and the sanction corresponding to the test according to a time sequence programmed by the operator. Consequently, each reception equipment comprises a program in memory containing instructions to execute a set of tests previously memorised in the decoder to detect a particular use of said decoder or said security processor and instructions to execute at least one action associated with the executed test, according to a time sequence predefined for each particular detected use.

Step 24 comprises a test 26 consisting of verifying whether or not a situation corresponding to an active detection has occurred.

If it has, the step 28 consists of executing sanctions associated with the active detection when these sanctions have been triggered by the operator.

The decoder memorises a record of the active detection and sanctions executed.

If the situation corresponding to an active detection does not arise, the sanctions associated with the active detection are not applied.

In step 30, the terminal equipment transmits records of detections applied and sanctions executed to the central management site. According to one additional characteristic, the central management site can reinitialise previously memorised detections in a reception equipment, or it can delete the effect of a previously applied sanction following a detection.

1. Method for an operator remote controlling of the use of reception equipment in a digital data broadcasting network, characterised in that it comprises the following steps:
a—defining a set of tests that can be remotely activated in said reception equipment and the results of which can be used to identify at least one particular use of at least one part of the reception equipment,
b—defining a set of actions that can be executed in said reception equipment designed to control operation of said equipment,
c—dynamically and remotely associating at least one action defined in step b), with each test defined in step a),
d—remotely activating by the operator at least one test among the tests defined in step a).

2. Method according to claim 1, characterised in that the method also includes a step consisting of remotely triggering at least one action associated with a test activated as a function of the result of said test.

3. Method according to claim 2, characterised in that an action associated with a given test is triggered according to a time sequence programmed by the operator.

4. Method according to claim 1, characterised in that each defined test is either an elementary test or a combination of elementary tests pre-programmed in the reception equipment, and each defined action associated with said test is either an elementary action or a combination of elementary actions pre-programmed in the reception equipment.

5. Method according to claim 4, in which the operator sends a description of the defined tests to the reception equipment and/or a description of the defined actions.

6. Method according to claim 1, characterised in that the operator sends a list of test/action associations and/or a description of time sequence related to each test/action association to said reception equipment.

7. Method according to claims 3, 5, or 6, characterised in that said description of the defined tests, said description of the defined actions, said description of the list of test/action associations and/or the description of the time sequence related to each test/action association are recorded in a non-volatile memory of the reception equipment.

8. Method according to claim 7, characterised in that recorded descriptions are encrypted in non-volatile memory.

9. Method according to claim 2, in which the reception equipment transmits a record of executed tests and actions to the operator.

10. Method according to claims 3, 5, or 6, characterised in that said descriptions are transmitted to the reception equipment in a secure EMM message.

11. Method according to claims 3, 5, or 6, characterised in that said descriptions are transmitted to the reception equipment in a private data flow.

12. Method according to claim 1, characterised in that the order to activate a test is transmitted to the reception equipment in a secure EMM message.

13. Method according to claim 2, characterised in that the order to activate an action associated with an activated test is transmitted to the reception equipment in a secure EMM message.

14. Method according to claim 10, 12 or 13, characterised in that the data structure format of said EMM message when it is transmitted to a reception equipment comprises:
an 8-bit <<table_id>> field with hexadecimal value 88 identifying the message as an EMM-U message intended to a unique reception equipment,
a 1-bit <<section_syntax_indicator>> field with value equal to 0 identifying the format of the message continuation,
a 1-bit <<DVB_reserved>> field and a 2-bit <<ISO_reserved>> field intended for future use,
a 12-bit <<EMM-U_section_length>> field giving the number of bytes making up the message continuation,
a 40-bit <<unique_address_field>> field containing the unique address of the reception equipment to which the message is intended,
a set of 8-bit <<EMM_data_byte>> fields representing the functional parameters carried by the message.

15. Method according to claims 10, 12 or 13, characterised in that the data structure format of said EMM message when it is transmitted to a group of reception equipment comprises:
an 8-bit <<table_id>> field with hexadecimal value 8A or 8B identifying the message as an EMM-G message intended to a group of reception equipment,
a 1-bit <<section_syntax indicator>> field with value equal to 0 identifying the format of the message continuation,
a 1-bit <<DVB_reserved>> field and a 2-bit <<ISO_reserved>> field intended for future use,
a 12-bit <<EMM-G_section_length>> field giving the number of bytes making up the message continuation,
a set of 8-bit <<EMM_data_byte>> fields representing the functional parameters carried by the message,

16. Method according to claim 10, 12 or 13, characterised in that the data structure format of said EMM message when it is transmitted to a group of reception equipment comprises:
an 8 bits <<table_id>> field with hexadecimal value 8E identifying the message as an EMM-S message intended to a sub-group in a group of reception equipment,
a 1-bit <<section_syntax_indicator>> field with value equal to 0 identifying the format of the message continuation,
a 1-bit <<DVB_reserved>> field and a 2-bit <ISO_reserved>> field intended for future use,
a 12-bit <EMM-S_section_length>> field giving the number of bytes making up the message continuation,
a 24-bit <<shared_address_field>> field containing the address of the reception equipment sub-group to which the message is intended,
a 6-bit <<reserved>> field intended for future use,
a 1-bit <<data_format>> field with value equal to 0 or 1 specifying if the functional parameters carried by the message are encrypted according to a fixed or variable format,
a 1-bit <<ADF_scrambling_flag>> field with value equal to 0 or 1 specifying whether or not the field containing functional parameters of the message giving the list of the concerned reception equipment in the sub-group is encrypted,
a set of 8-bit <<EMM_data_byte>> fields representing the functional parameters carried by the message.

17. Method according to claim 1, characterised in that the order to activate a test is transmitted to the reception equipment in a private data flow.

18. Method according to claim 2, characterised in that the order to start execution of an action associated with a test is transmitted to the reception equipment in a private data flow.

19. Method according to claim 1, characterised in that broadcast digital data represent audiovisual programs.

20. Reception equipment comprising a decoder and a security processor, characterised in that it also comprises:
means for executing a set of predefined tests to detect particular use of the decoder or the security processor,
means for executing at least one action previously associated with the executed test, using a time sequence predefined for each particular detected use.

21. Reception equipment according to claim 20, characterised in that it is connected through a backward channel to a central management site to transmit a record of the tests and actions executed, to this central site.

22. Reception equipment according to claim 20, characterised in that the security processor is a smart card.

23. Decoder designed to cooperate with a security processor to control access to scrambled digital data broadcast by an operator to a set of a reception equipment, characterised in that it comprises:
a non-volatile memory containing at least one predefined test to detect particular use of the decoder or the security processor, and at least one predefined action associated with said test that can be activated remotely by the operator,
a first module designed to execute at least one of the memorised tests,
a second module designed to execute at least one action associated with the executed test, according to a time sequence predefined for each particular detected use.

24. System for broadcasting digital data comprising a central management site and a set of reception equipment, each equipment comprising a decoder and a security processor, system characterised in that it comprises:
means for defining a set of tests that can be activated in each decoder and the results of which are used to identify at least one particular use of the decoder or the security processor,
means for defining a set of actions that can be executed in said decoder,
means for transmitting a description of the defined tests, a description of the defined actions, a description of the list of test/action associations and/or a description of the time sequence related to each test/action association, to each decoder,
means for remotely activating at least one test among the defined tests, and
means for remotely triggering at least one action associated with the activated test as a function of the result of said test.

25. Computer program that can be executed on a set of reception equipment that can receive digital data broadcast by an operator and each including a decoder and a security processor, characterised in that it also includes instructions to execute a set of tests previously memorised in the decoder to detect a particular use of said decoder or said security processor and instructions to execute at least one action associated with the executed test, according to a time sequence predefined for each particular detected use.
